(19) United States
(12) Patent Application Publication
(10) Pub. No.: US 2003/0213740 A1
(43) Pub. Date: Nov. 20, 2003

(54) Multi-well equilibrium dialysis systems

(76) Inventor: Andrew Creasey, Bedford, MA (US)

Correspondence Address: Edward D. Grieff, Esq., Hale and Dorr LLP, 1455 Pennsylvania Avenue, NW, Washington, DC, 20004, US

(21) Appl. No.: 10/309,052

(22) Filed: Dec. 4, 2002

Related U.S. Application Data
(63) Continuation of application No. PCT/US01/18070, filed on Jun. 5, 2001.

(51) Int. Cl. B01D 61/28

(52) U.S. Cl. 210/321.6; 210/321.72; 210/321.75; 210/321.84; 422/99; 422/101; 422/102; 435/288.3; 435/288.4

(57) ABSTRACT

This invention relates to equilibrium dialysis systems in multi-well formats for simultaneously preparing multiple samples. The equilibrium dialysis systems described herein may be made in 8-well, 12-well, 96-well, 384-well, 1536-well or other multi-well formats. The equilibrium dialysis systems can be used for protein binding assays, molecule-molecule interaction studies, tissue cultures and many other biological and chemical applications.

### RELATED APPLICATIONS

This application is a continuation of PCT/US01/18070 filed Jun. 5, 2001, which claims priority to U.S. application Ser. No. 09/586,985 filed Jun. 5, 2000, issued as U.S. Pat. No. 6,458,275, the disclosures of which are incorporated by reference herein in its entirety.

### FIELD OF THE INVENTION

This invention relates to equilibrium dialysis systems in multi-well formats for simultaneously preparing multiple samples. The equilibrium dialysis systems described herein may be made in 8-well, 12-well, 96-well, 384-well, 1536-well or other multi-well formats. The equilibrium dialysis systems can be used for protein binding assays, molecule-molecule interaction studies, tissue cultures and many other biological and chemical applications.

### BACKGROUND OF THE INVENTION

Current and developing drug discovery and biomedical research applications, such as high throughput screening, rely on the simultaneous preparation of large numbers of samples for the rapid purification and identification of desired molecules and samples. In such applications, hundreds or even thousands of samples often need to be prepared simultaneously using techniques such as equilibrium dialysis. The equilibrium dialyzers currently available on the market are single well or single chamber systems designed for the preparation of a single sample at any given time. The present invention satisfies the need for an equilibrium dialysis system that can be used for simultaneously preparing large numbers of samples.

### SUMMARY OF THE INVENTION

The invention provides equilibrium dialysis systems having multiple wells, wherein each well comprises an upper chamber having an open end, a lower chamber having an open end, and a semi-permeable membrane between the upper chamber and the lower chamber. The equilibrium dialysis system may comprise 8 wells, 12 wells, 96 wells, 384 wells, 1,536 wells or any other number of wells. The upper chamber and the lower chamber may be made of the same or different materials, may have the same or different shapes, and may have the same or different volumes. The upper chamber and/or lower chamber may have removable closures on one or more wells.

The inside walls of the upper chamber and/or lower chamber may each be independently modified with chromatographic materials, enzymes, antibodies, cyclodextrins, lectins, metal ions, ligands or mixtures thereof. In other embodiments, the inside walls of the upper chamber and/or lower chamber may each be independently modified with poly-L-lysine, poly-D-lysine, DEAE-dextran, poly-L-arginine, poly-L-histine, poly-DL-ornithine, protamine, collagen type 1, collagen type IV, gelatin, fibronectin, laminin, chondronectin, or mixtures thereof. In still other embodiments, the inside walls of the upper chamber and/or lower chamber may each independently have a surface matrix coating comprising at least one chromatographic material and, optionally, at least one polymer.

The invention also provides kits comprising equilibrium dialysis systems, and methods for using the equilibrium dialysis systems.

The invention provides methods for conducting binding assays by adding a first sample to the upper chamber of at least one well in the equilibrium dialysis system of the invention, where the first sample cannot pass through the membrane; adding a second sample to the lower chamber of the equilibrium dialysis system, wherein the second sample can pass through the membrane; allowing the first sample and the second sample to equilibrate; and quantitatively or qualitatively assaying the resulting sample.

The invention provides methods for growing cells by adding a cell to the upper chamber or lower chamber of at least one well in the equilibrium dialysis system of the invention; and culturing the cell in the equilibrium dialysis system.

The invention also provides methods for ultrafiltration by adding a sample to the upper chamber or lower chamber of at least one well in the equilibrium dialysis system of the invention, and applying a pressure differential across the membrane to dialyze the sample.

These and other aspects of the invention are described in more detail herein.

### BRIEF DESCRIPTION OF THE DRAWINGS

FIGS. 1A-C are views of a 96-well format equilibrium dialysis system. FIG. 1A is an optional top closure. FIG. 1B is the 96-well format equilibrium dialysis system. FIG. 1C is an optional bottom closure.

FIG. 2 is a vertical cross-sectional view of one well in the multi-well equilibrium dialysis system of the invention. In FIG. 2, the open end of the first chamber and the open end of the second chamber are opposite the semi-permeable membrane.

FIG. 3 is is a vertical cross-sectional view of one well in the multi-well equilibrium dialysis system of the invention showing a gasket on each side of the membrane.

### DETAILED DESCRIPTION OF THE INVENTION

The invention provides equilibrium dialysis systems in multi-well formats for the simultaneous preparation of multiple samples with applications including, but not limited to, high throughput screening, binding assays and bio-molecule interactions (e.g., protein-protein interactions). The invention provides equilibrium dialyzers in 8-well, 12-well, 96-well, 384-well, 1536-well, and other multi-well formats.

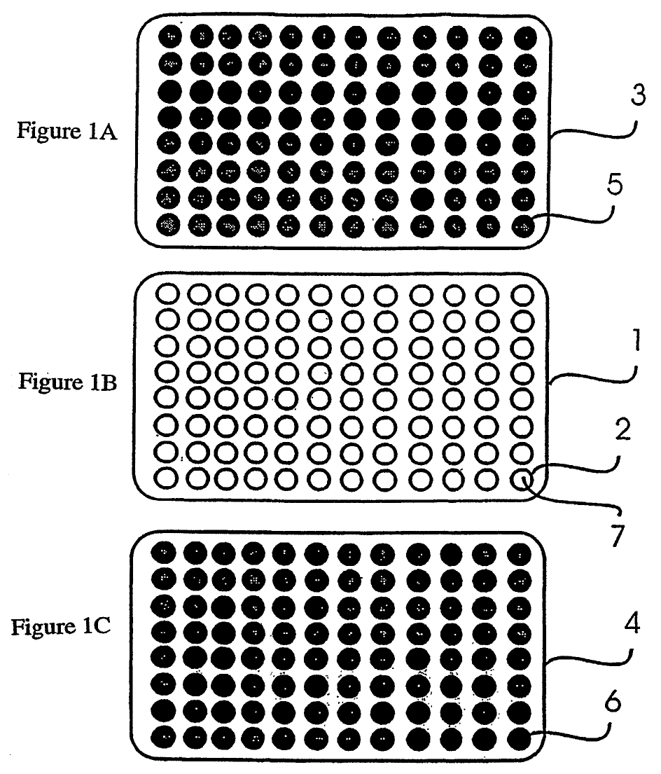

FIG. 1B is expanded view of a 96-well format equilibrium dialysis system 1. The 96-well system 1 has 96 individual wells 2 arranged in the system. The equilibrium dialysis system 1 described herein may also be made in 8-well, 12-well, 384-well, 1536-well or other multi-well formats.

FIGS. 1A and 1C show a top closure mat 3 and a bottom closure mat 4, respectively, having 96 individual closures for the top 5 and bottom 6 of each of the wells 2 shown in FIG. 1B. The closure mats 3, 4 or individual closures 5, 6 may be made of one or more materials. Exemplary materials include fluorocarbons, silicons, polytetrafluoroethylenes (e.g., TEFLON® by DuPont), polysulfones, polyethersulfones, polyolefins (e.g., polypropylene, polyethylene, and mixtures thereof), polyethylene/ethylene vinyl acetate copolymers, thermoplastic elastomers, polymethyl methacrylates, polystyrenes, polystyrene/acrylonitrile copolymers, polyvinylidenefluorides (PVDF), glass, and the like. The portion of the closures that will ultimately come into contact with the sample can optionally be modified with chromatographic materials, enzymes, antibodies, cyclodextrins, lectins, metal ions, and/or ligands.

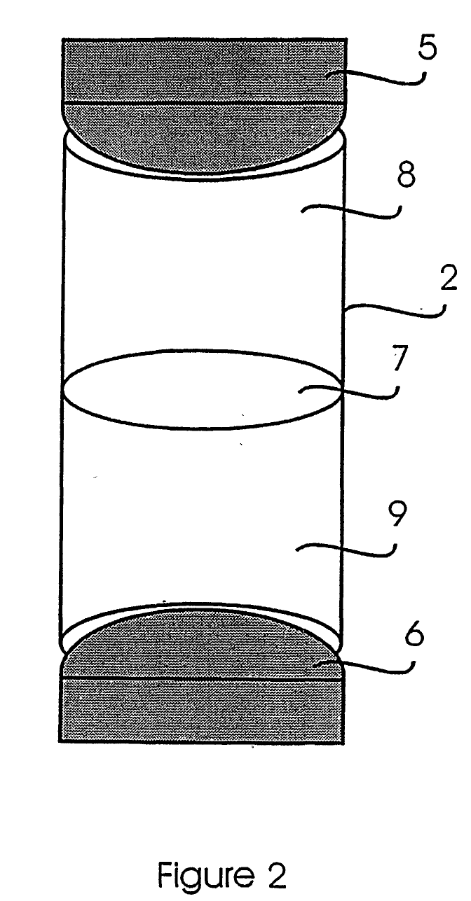

FIG. 2 is an expanded view of a vertical cross-section of one well in the multi-well format equilibrium dialysis system of the invention. As shown in FIG. 2, each well 2 of the equilibrium dialysis system has an upper chamber 8 and a lower chamber 9 separated by a semipermeable membrane 7. The upper chamber 8 and the lower chamber 9 may be made of the same or different materials. The upper chamber 8 and the lower chamber 9 may have the same or different volumes. The upper chamber 8 and the lower chamber 9 may have the same or different shape.

The upper chamber and the lower chamber may each independently be made of any material known in the art. Exemplary materials include fluorocarbons, polytetrafluoroethylenes (e.g., TEFLON® by DuPont), polyolefins (e.g., polypropylene, polyethylene, and mixtures thereof), polysulfones, polyethersulfones, polyetheretherketones, polymethyl methacrylates, polystyrenes, polystyrene/acrylonitrile copolymers, polyvinylidenefluorides (PVDF), glasses, and the like.

The material on the inside walls of the upper chamber and/or the lower chamber may independently and optionally be physically and/or chemically modified with any functional group known in the art. For example, the inside walls of the upper chamber and/or the lower chamber may each independently and optionally be physically and/or chemically modified with chromatographic materials, enzymes, antibodies, cyclodextrins, lectins, metal ions, and/or ligands. In other embodiments, the inside walls of the upper and/or lower chamber may each independently and optionally by physically and/or chemically modified with, for example, poly-L-lysine, poly-D-lysine, DEAE-dextran, poly-L-arginine, poly-L-histine, poly-DL-ornithine, protamine, collagen type 1, collagen type IV, gelatin, fibronectin, laminin, chondronectin, and the like.

The enzymes, antibodies, cyclodextrins, lectins, metal ions and ligands may be any known in the art. The chromatographic materials may be any known in the art, including, for example, materials for ion-exchange chromatography, size-exclusion chromatography, affinity chromatography, gradient chromatography, hydrophobic chromatography, chiral chromatography, and mixtures thereof. Exemplary chromatographic materials include polysaccharides (e.g., cellulose, agarose, crosslinked polysaccharide beads (commercially available as SEPHAROSE® and SEPHADEX®)), polymers (e.g., polystyrene, polytetrafluoroethylenes (PTFE) (e.g., TEFLON® from DuPont), styrenedivinyl-benzene based media, polymer beads, PMMA (PERSPEX®), polyacrylamide), silicas (e.g., silica, silica gel, silica gel-containing phosphors, glass, controlled pore glass (CPG)), or metals (e.g., aluminum oxide, zirconium, titanium). The chromatographic materials can be chemically and/or physically modified, and may be porous or non-porous. For example, styrenedivinyl-benzene based media may be modified with, for example, sulphonic acids, quaternary amines and the like. Silicas (e.g., silica, silica gel, silica gel-containing phosphors, glass, CPG) may be modified with, for example, C₂, C₄, C₆, C₈ or C₁₈ or ion exchange functionalities. Chromatographic materials may be physically modified with, for example, enzymes, antibodies, cyclodextrins, lectins, metal ions, and/or ligands. The chromatographic materials may have any regular (e.g., spherical) or irregular shape, or may be shards, fibers, powders or mixtures thereof.

The volume of the upper chamber 8 and the volume of the lower chamber 9 may independently be, for example, from about 1 oil to about 5,000 μl. The volumes of the upper chamber and the lower chamber may range from about 10 μl to about 200 μl; or from about 50 μl to about 200 μl; or from about 25 μl to about 300 μl; or from about 500 μl to about 1,500 μl; or from about 3,000 μl to about 5,000 μl. In preferred embodiments, the volume of the upper chamber 8 and the lower chamber 9 may independently be from about 75 μl to about 250 μl, or from about 200 μl to about 250 μl.

The shape of the upper chamber 8 and the shape of the lower chamber 9 may independently be, for example, a cube, cylinder, rectangular prism, pentagonal prism, triangular prism, hexagonal prism, cone, pyramid, tetrahedron, and the like.

The semi-permeable membrane 7 may be of any molecular weight cut-off known in the art, and may be of any material known in the art. Exemplary molecular weight cut-offs are, for example, from 100 Daltons to 10 million Daltons. Membranes may have molecular weight cuts-offs of, for example, 100 Daltons, 500 Daltons, 1,000 Daltons, 2,000 Daltons, 5,000 Daltons, 10,000 Daltons, 25,000 Daltons, 50,000 Daltons, 100,000 Daltons, and 300,000 Daltons. Alternatively, the membrane may have a pore size from about 0.01 microns to about 1 micron. Membranes may have pore sizes of, for example, 0.01 microns, 0.05 microns or 0.60 microns.

Exemplary membrane materials include celluloses (e.g., regenerated celluloses), cellulose acetates, polytetrafluoroethylenes (e.g., TEFLON® by DuPont), polysulfones, nitrocelluloses, polycarbonates, polyolefins (e.g., polypropylene, polyethylene, and mixtures thereof), polyamides, polyvinylidenefluorides, and the like.

Each well in the multi-well equilibrium dialysis system of the invention may have membranes that have different molecular weight cut-offs and/or that are made of different materials.

The membrane may be placed between the two chambers in the equilibrium dialysis systems by any physical or chemical method known in the art. Physical and chemical methods for placing the membrane between the two chambers include, for example, physical placement, adhesion, bonding, chemical attachment, and heat-based sealing. Physical placement may involve using all or part of the upper and/or lower chamber to guide the membrane into place, and then physically locking the upper and/or lower chamber into place using, for example, a press fit, a snap fit, a screw fit. Physical placement may optionally involve the use of a gasket. Adhesion may involve applying liquid and/or solid adhesives, such as cyanoacrylate, acrylic, urethane, epoxy or silicone, to the upper chamber, lower chamber and/or membrane to secure the membrane into place. Adhesion may optionally also involve physical placement, such as the use of a gasket. Bonding may involve ultrasonically attaching the membrane to the upper and/or lower chamber. Heat-based sealing may involve melt bonding the membrane to the upper and/or lower chamber. Any combination of these or other methods may be used to place the membrane between the upper and lower chambers.

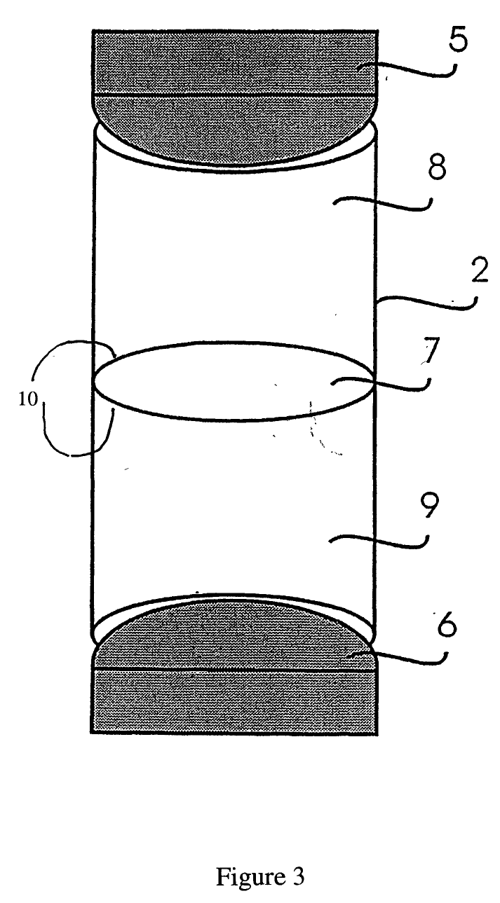

The two chambers may be placed together through the use of at least one gasket. In one embodiment, the membrane serves as the gasket. In other embodiments, the gasket is made of a fluorocarbon and/or a polyolefin (e.g., polypropylene, polyethylene, or a mixture thereof). In still other embodiments, the gasket is made of the membrane and a fluorocarbon, and/or a polyolefin (e.g., polypropylene, polyethylene, or a mixture thereof). In other embodiments, the gasket may be a liquid, such as, for example, a polymer or an adhesive. The liquid may dry after the chambers are placed together. In a preferred embodiment as shown in FIG. 3, two gaskets 10 are used, in which one gasket 10 is present on each side of the membrane adjacent the walls of the chambers. In other embodiments, only one gasket 10 can be used on either side of the membrane and adjacent the walls of the chambers. The gasket does not interfere with the passage of the sample through the membrane between the chambers.

FIG. 2 also shows a vertical cross-section of the closure mat having individual top 5 and bottom 6 closures for the open ends of the top 8 and bottom 9 chambers, respectively. The two closures 5, 6 can also be of the same or different shapes and sizes to appropriately mate with the corresponding chamber. Each of the closures may be part of a multi-well closure designed to close all wells of the equilibrium dialysis system simultaneously or may be part of a closure system designed to close only selected wells in the multi-well system. For example, the closure mat may be a single closure mat to cover a single well or to cover selected wells. As another example, the closure mat may have 8 individual closures to cover a strip on a well-plate. The closures 5, 6 may also be part of an adhesive sheet, strip or layer. The closures 5, 6 can also be self-sealing such that the closure will seal after the delivery of sample through the closure into the sample chamber 8, 9.

The samples can be placed into or removed from the chambers using a syringe, needle or other mechanism that eliminates the need to attach or remove the closures after or prior to sample placement. The closure mats may be removably attached to the multi-well plate or may be permanently attached to the multi-well plates.

The inside walls of the upper chamber 8 and the lower chamber 9 may independently and optionally be coated with a surface matrix coating comprising at least one chromatographic material. In another embodiment, the inside walls of the upper chamber 8 and the lower chamber 9 may independently and optionally be coated with a surface matrix coating comprising at least one chromatographic material and at least one polymeric substance. For example, the upper chamber may be coated with a surface matrix coating, and the lower chamber may not have a surface matrix coating, or vice versa. As another example, the upper chamber may be coated with a surface matrix coating, and the lower chamber may be coated with a different surface matrix coating. As yet another example, the upper and lower chambers may be coated with the same surface matrix coating. The surface matrix coating may optionally comprise other materials such as, for example, gels, bacteria, living cells, solid powders, other functional groups, or mixtures thereof.

The chromatographic materials may be any known in the art, including, for example, materials for ion-exchange chromatography, size-exclusion chromatography, affinity chromatography, gradient chromatography, hydrophobic chromatography, chiral chromatography, and mixtures thereof. Exemplary chromatographic materials include polysaccharides (e.g., cellulose, agarose, crosslinked polysaccharide beads (commercially available as SEPHAROSE® and SEPHADEX®)), polymers (e.g., polystyrene, polytetrafluoroethylenes (PTFE) (e.g., TEFLON® from DuPont), styrenedivinyl-benzene based media, polymer beads, PMMA (PERSPEX®), polyacrylamide), silicas (e.g., silica, silica gel, silica gel-containing phosphors, glass, controlled pore glass (CPG)), or metals (e.g., aluminum oxide, zirconium, titanium). The chromatographic materials can be chemically and/or physically modified, and may be porous or non-porous. For example, styrenedivinyl-benzene based media may be modified with, for example, sulphonic acids, quarternary amines and the like. Silicas (e.g., silica, silica gel, silica gel-containing phosphors, glass, CPG) may be modified with, for example, C₂, C₄, C₆, C₈ or C₁₈ or ion exchange functionalities. Chromatographic materials may be physically modified with, for example, enzymes, antibodies, cyclodextrins, lectins, metal ions, and/or ligands. The chromatographic materials in the surface matrix coating may have any regular (e.g., spherical) or irregular shape, or may be shards, fibers, powders or mixtures thereof.

In the surface matrix coating, the polymeric substance may be any known in the art. Exemplary polymeric substances include polytetrafluoroethylenes (PTFE) (e.g., TEFLON® from DuPont), polysulfones, polyethersulfones, cellulose acetates, polystyrenes, polyvinylchlorides, polycarbonates, polystyrene/acrylonitrile copolymers, polyvinylidenefluorides, or mixtures thereof.

The present invention also provides kits comprising the multi-well equilibrium dialysis systems described herein. The kits can comprise one or more well-systems, top closures, bottom closures, membranes, growth blocks, reagents, buffers (e.g., lysis buffers, wash buffers), cells, filters, collection tubes, plate rotators, clamps, syringes, pipette tips, chromatographic materials, and user manuals. The term “kit” includes, for example, each of the components combined together in a single package, the components individually packaged and sold together, or the components presented together in a catalog (e.g., on the same page or double-page spread in the catalog).

With rapid progress in drug screening and discovery and advances in biomedical research, equilibrium dialysis is becoming an increasingly important technique for protein binding assays, molecule-molecule interaction studies, tissue cultures and many other biological and chemical applications.

To use the equilibrium dialysis system of the invention to conduct a binding assay (e.g., receptor-ligand assay), one sample chamber may be filled with a protein sample (e.g., receptor). The protein sample contains molecules that are too large to pass through the pores of the membrane. The second chamber is filled with small molecules (e.g., ligand) that can pass through the pores of the membrane. When this system is allowed to equilibrate, the small molecules will be present in both chambers, i.e., on each side of the membrane. If the small molecules bind to the protein, the state of equilibrium will be affected such that more small molecules will be present in the protein sample chamber than in the small molecule sample chamber. During and upon completion of equilibrium dialysis, quantitative and/or qualitative assays can be performed to further study the samples. This method is frequently used in new drug discovery methods. By choosing appropriately-sized membranes, equilibrium dialysis may also be used to study DNA-protein interactions, protein-protein interactions, and many other interactions between bio-molecules and other molecules.

In cell culturing, the cells can be placed in one sample chamber. Nutrients and other molecules can be added to the other sample chamber and be introduced to the cells through equilibrium dialysis. To study the interaction between small molecules and cells, small molecules can be added to the sample chamber to diffuse through the membrane and interact with the cells in the cell-containing chamber. During and upon completion of equilibrium dialysis, quantitative and/or qualitative assays can be performed to further study the samples.

For growing adherent cells, the cell-containing chamber may be made of a material that would provide a surface on which the cells could adhere (e.g., polystyrenes, polytetrafluoroethylenes, polyvinylchlorides, polycarbonates, titanium, or mixtures thereof). The material of the cell-containing chamber may further comprise coating agents, such as, for example, poly-L-lysine, poly-D-lysine, DEAE-dextran, poly-L-arginine, poly-L-histine, poly-DL-ornithine, protamine, collagen type 1, collagen type IV, gelatin, fibronectin, laminin, chondronectin, and the like. Alternatively, the cell-containing chamber may contain a surface coating, such as the surface matrix coating described herein, which may further comprise coating agents, such as, for example, poly-L-lysine, poly-D-lysine, DEAE-dextran, poly-L-arginine, poly-L-histine, poly-DL-ornithine, protamine, collagen type 1, collagen type IV, gelatin, fibronectin, laminin, chondronectin, and the like.

The equilibrium dialysis system of the invention may also be used for ultrafiltration by providing a pressure differential across the membrane. The pressure differential may be produced, for example, by vacuum, pressurized inert gas, or centrifugal force. In ultrafiltration using vacuum dialysis, a vacuum may be placed on the chamber containing the dialysis buffer, while the pressure in the sample-containing chamber remains the same.

### EXAMPLE

The following example is for purposes of illustration only and is not intended to limit the scope of the claims.

The equilibrium dialysis system described in the present invention was used to perform equilibrium dialysis of a sample of Vitamin B12. 1 milligram of Vitamin B12 was dissolved in 100 milliliters of PBS buffer (phosphate buffer saline). 150 microliters of this solution were added to each top well of a 96-well plate containing 10K Dalton molecular weight cut-off membranes. Closures were used to seal the top wells. 150 micro liters of PBS buffer were added to each bottom well of the same plate. Closures were used to seal the bottom wells. The dialysis system was rotated at 10 rpm using a rotator, for 24 hours at room temperature. Samples were collected from all the top and bottom chambers for analysis.

Various modifications of the invention, in addition to those described herein, will be apparent to one skilled in the art from the foregoing description. Such modifications are intended to fall within the scope of the appended claims.

What is claimed is:

1. An equilibrium dialysis system having at least 8 wells, wherein each well comprises an upper chamber having an open end, a lower chamber having an open end, and a semi-permeable membrane between the upper chamber and the lower chamber.

2. The equilibrium dialysis system of claim 1, wherein the material of the upper chamber and lower chamber is independently selected from a fluorocarbon, a polytetrafluoroethylene, a polysulfone, a polyethersulfone, a polyolefin, a polyetheretherketone, a polymethyl methacrylate, a polystyrene, a polystyrene/acrylonitrile copolymer, a polyvinylidenefluoride, glass, or a mixture thereof.

3. The equilibrium dialysis system of claim 1, where the upper chamber and the lower chamber independently have a volume of from 1 μl to 5 ml.

4. The equilibrium dialysis system of claim 1, having at least 12 wells.

5. The equilibrium dialysis system of claim 1, having at least 96 wells.

6. The equilibrium dialysis system of claim 1, having at least 384 wells.

7. The equilibrium dialysis system of claim 1, having at least 1,536 wells.

8. The equilibrium dialysis system of claim 1, where the membrane has a molecular weight cut-off from about 100 Daltons to about 10 million Daltons.

9. The equilibrium dialysis system of claim 1, where the membrane is a cellulose, a cellulose acetate, a polytetrafluoroethylene, a polysulfone, a nitrocellulose, a polycarbonate, a polyvinylidenefluoride, a polyolefin, a polyamide, or a mixture thereof.

10. The equilibrium dialysis system of claim 1, further comprising at least one closure adjacent at least one upper chamber.

11. The equilibrium dialysis system of claim 1, further comprising at least one closure adjacent at least one lower chamber.

12. The equilibrium dialysis system of claim 1, wherein the upper chamber is chemically or physically modified with at least one material selected from a chromatographic material, an enzyme, an antibody, a cyclodextrin, a lectin, a metal ion, and a ligand.

13. The equilibrium dialysis system of claim 1, wherein the lower chamber is chemically or physically modified with at least one material selected from a chromatographic material, an enzyme, an antibody, a cyclodextrin, a lectin, a metal ion, and a ligand.

14. The equilibrium dialysis system of claim 1, wherein the upper chamber further comprises a surface matrix coating comprising at least one chromatographic material.

15. The equilibrium dialysis system of claim 1, wherein the lower chamber further comprises a surface matrix coating comprising at least one chromatographic material.

16. A kit comprising the equilibrium dialysis system of claim 1.

17. The kit of claim 16, further comprising at least one closure for an upper chamber or at least one closure for a lower chamber.

18. An equilibrium dialysis system comprising at least 96 wells, wherein each well comprises an upper chamber having an open end, a lower chamber having an open end, a semi-permeable membrane between the upper chamber and the lower chamber; wherein the upper chamber and the lower chamber are each independently made of a fluorocarbon, a polypropylene, polyethylene, or a mixture of two or more thereof.

19. The equilibrium dialysis system of claim 18, further comprising at least one gasket made of a fluorocarbon, a polyethylene, a polypropylene, or a mixture of two or more thereof.

20. An equilibrium dialysis system comprising at least 96 wells, wherein each well comprises an upper chamber having an open end and a removable closure, a lower chamber having an open end and a removable closure, and a semi-permeable membrane between the upper chamber and the lower chamber; wherein the upper chamber, the removable closure of the upper chamber, the lower chamber, and the removable closure of the lower chamber are each independently made of a fluorocarbon, a polypropylene, a polyethylene, or a mixture of two or more thereof.
